(19) United States
(12) Patent Application Publication
(10) Pub. No.: US 2025/0326480 A1
(43) Pub. Date: Oct. 23, 2025

(54) PROTECTIVE MAGENTICALLY ATTACHABLE EDGE GUARD FOR WEAPONS BAY DOOR

(71) Applicant: Government of the United States as represented by the Secretary of the Air Force, Wright-Patterson AFB, OH (US)

(72) Inventors: Christopher O'Donnell, Hill AFB, UT (US); Jeremiah Hamilton, Hill AFB, UT (US)

(21) Appl. No.: 18/642,155

(22) Filed: Apr. 22, 2024

(51) Int. Cl. B64C 1/14

(52) U.S. Cl. CPC B64C 1/1461

(57) ABSTRACT

An edge guard for protecting door edges. The edge guard is elongate with a C-shaped or J-shaped cross section configured to fit a specific edge to be protected. The cross section has two legs and an intermediate channel which fits onto the door edge. The edge guard has alternating segments and discontinuities in longitudinal direction. The segments are specifically sized to match corresponding sections of the edge to be protected. Adjacent segments may be angularly disposed within the plane of the channel, out of the plane of the channel or both. Predetermined segments have embedded magnets for removable attachment to the door.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to magnetically attachable edge guards and more particularly to magnetically attachable edge guards which can fit edges having discontinuities in the plane of the edge and discontinuities out of the plane of the edge.

### BACKGROUND OF THE INVENTION

Production of the Lockheed Martin F-35 airframe began Nov. 10, 2003 with the first flight having been completed Dec. 15, 2006. The F-35 is a single seat stealth-capable aircraft capable. The F-35 is said to be the most advanced aircraft in the world and expected to replace a host of other fighter aircraft, both domestically and internationally. The F-35 airframe is executed in three platforms: the F-35A Lightening II designed for conventional runways and the most common platform; the F-35B Lightening II with vertical landing and short-field takeoff capability and the F-35C Lightening II built for aircraft carrier operations. More than 1500 companies and 250000 jobs are involved in the supply chain and production of the F-35 airframe.

A critical part of all three platforms of the F-35 airframe, and of other fighter jets is the weapons bay door [WBD] system. Two WBDs hingedly open in opposed fashion to hang down from the underside of the fuselage. With the WBDs open, maintenance on and reloading of the weapons bay can occur.

But as the WBDs hang down, clearance between the edge of the door and the maintenance vehicles, armaments and tools is compromised for all three platforms. Collision with the WBD results in damage requiring major repair or replacement. Furthermore, damage to the WBD drive system may occur, requiring even further time and attention.

Attempts to protect the WBD include covering the edges with foam bumpers, such as are sold may be by Trisoft Covers Inc. In 2015 Trisoft Covers Inc. stated its covers “last 10 times as long a any other product on the market.” See, https://www.aviationpros.com/tools-equipment/shopequipment/product/12062637/trisoft-aircraft-covers-maintenance-protection-kits. But these bumpers are typically XLPE foam, merely held in place by a friction fit. And these XLPE bumpers are easily dislodged from the intended protective position during routine maintenance and become ineffective.

Furthermore, many edges to be protected have discontinuities within the plane and out of the plane of the edge to be protected. Current bumpers require a separate and distinct bumper for each portion of the edge lying in a different plane or at a different angle within the same plane, increasing the number of bumpers and complexity of the maintenance task.

Accordingly, it is an object of this invention to address the longstanding need for protective edge guards which are not easily dislodged and which can accommodate the many edges having different planes or different angles within the same plane.

### SUMMARY OF THE INVENTION

In one embodiment the invention comprises an edge guard for protecting door edges. The edge guard comprises an elongate, resilient channel having a cross section configured to fit a specific door to be protected and a longitudinal direction perpendicular thereto, the channel having a first plurality of contiguous segments and a second plurality of discontinuities therebetween, whereby each segment is non-colinear with an adjacent segment; and a third plurality of discrete magnets disposed within the cross section, wherein the discontinuities are free of the discrete magnets.

In one embodiment the invention comprises a longitudinally elongate edge guard for protecting door edges. The edge guard comprises a resilient channel having a cross section with a first leg and a second leg joined by an apex and defining a channel therebetween configured to fit a specific door to be protected, the channel having a plurality of n contiguous segments and a plurality of n−1 discontinuities therebetween and being free of any magnet, whereby first and second adjacent segments lie in two different central planes; and plural discrete magnets disposed within each of the two adjacent segments

In one embodiment the invention comprises a method of protecting a door edge. The method comprises the steps of: determining the linear, angular and central plane measurements of plural contiguous sections of a door edge to be protected; providing an elongate blank having contiguous segments matching the respective linear and angular measurements separated by discontinuities, each of the segments having a respective central plane; embedding at least one magnet in each segment desired to be adhered to the door; heating the blank intermediate the at least one magnet in each segment until a localized region becomes flaccid in response to the heating; bending the blank at the flaccid localized region until the respective central planes of adjacent segments are non-coplanar and match the central plane measurements of the respective door sections; allowing the flaccid localized regions to harden to yield a resilient non-coplanar edge guard; and installing the edge guard on the corresponding door edge.

### BRIEF DESCRIPTION OF THE DRAWINGS

FIGS. 1A-7D are drawn to scale.

FIG. 1A is a perspective view of an edge guard according to the present invention.

FIG. 1B is a perspective view of an edge guard according to the present invention.

FIG. 1C is a perspective view of an edge guard according to the present invention.

FIG. 2A is a cross sectional view of an edge guard according to the present invention.

FIG. 2B is a cross sectional view of an edge guard according to the present invention.

FIG. 2C is a cross sectional view of an edge guard according to the present invention.

FIG. 2D is a cross sectional view of an edge guard according to the present invention.

FIG. 3A is a side view of an edge guard according to the present invention.

FIG. 3B is a side view of an edge guard according to the present invention.

FIG. 3C is a side view of an edge guard according to the present invention.

FIG. 4 is an enlarged perspective view of a segment of an edge guard according to the present invention having a cross section according to FIG. 2C.

FIG. 5A is a top plan view of the edge guard of FIG. 1A.

FIG. 5B is a bottom plan view of the edge guard of FIG. 5A.

FIG. 6A is a side view of a door edge guard according to the present invention and having segments of indeterminate length.

FIG. 6B is a side view of a door edge guard according to the present invention and having a segment of indeterminate length.

FIG. 7A is a top plan view of an edge guard according to the present invention having magnets disposed on the first leg.

FIG. 7B is a perspective view of an edge guard according to the present invention having embedded magnets shown in phantom.

FIG. 7C is a perspective view of an edge guard according to FIG. 1B showing embedded magnets in phantom.

FIG. 7D is an enlarged perspective view of a segment of the edge guard of FIG. 4 showing embedded magnets in phantom.

FIG. 8 is a schematic top plan view of an edge guard according to the present invention having heat applied to the discontinuities.

FIG. 9A is a schematic side elevational view of an edge guard according to the present invention having hinges at the discontinuities.

FIG. 9B is a schematic side elevational view of the edge guard of FIG. 9A after bending.

FIG. 10 is a schematic view of a user applying an edge guard according to the present invention to the edge of a door.

### DETAILED DESCRIPTION OF THE INVENTION

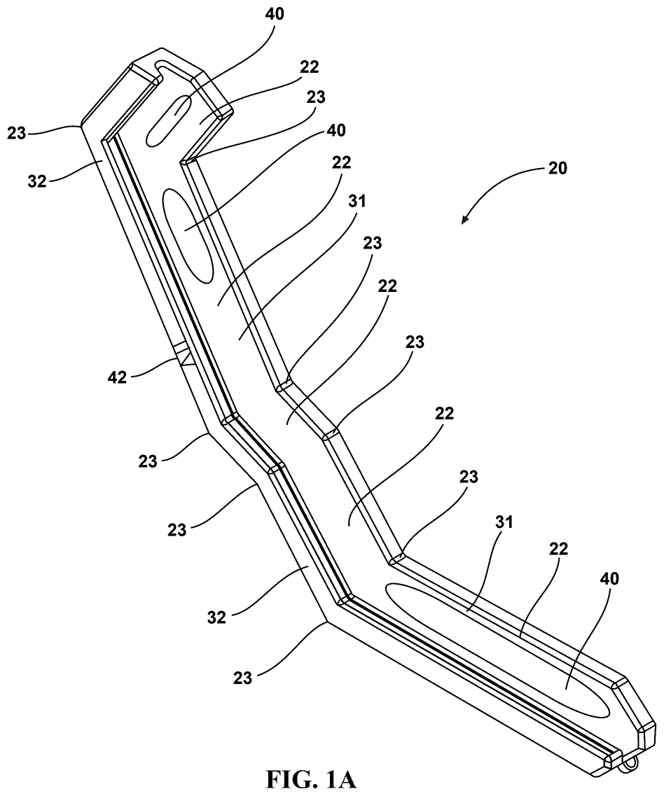

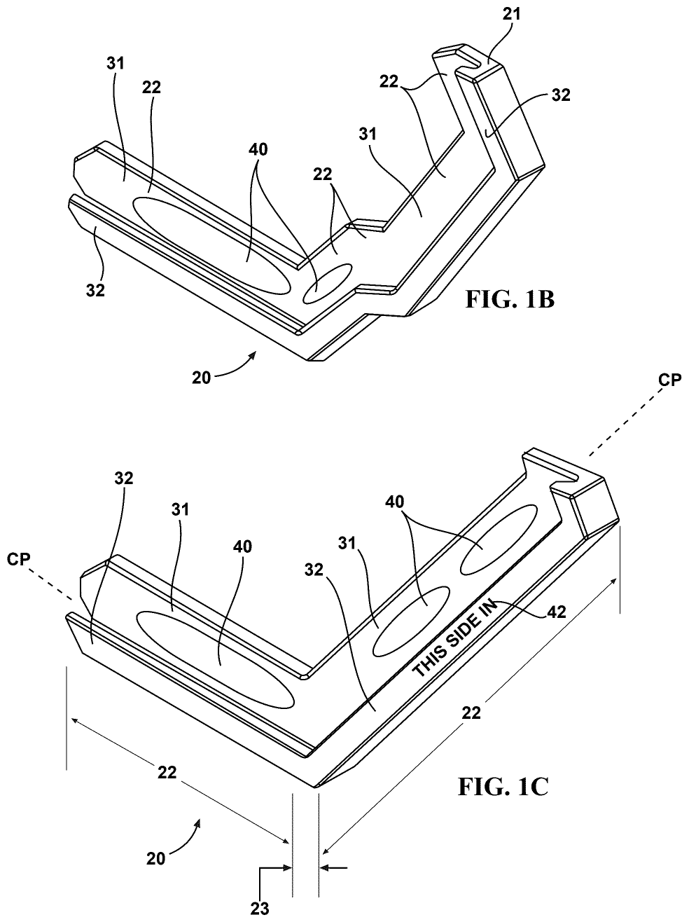

Referring to FIG. 1A, FIG. 1B and FIG. 1C, the invention comprises a multi-segment 22 edge guard 20 having two legs 31, 32 defining an open channel 35 therebetween. The edge guard 20 protects door 71 edges and similar features. The door 71 may be an open weapons bay door 71 of a fighter aircraft 74, such as an F-35 airframe, or other open door 71 of any other vehicle 73. The edge guard 20 is removed before the door 71 is closed.

The edge guard 20 is resilient, meaning the material of the edge guard 20 absorbs shock from impacts and strikes without permanent deformation or undue damage to the edge guard 20. The edge guard 20 is elongate, with a length in the longitudinal direction LD at least twice the largest width WD dimension of either leg 31, 32 taken perpendicular to the longitudinal direction LD. The depth DD of the channel 35 is taken from the bottom of the channel 35 to the distal end of the shortest leg. A segment 22 may have an aspect ratio, taken as the ratio of the greatest length in the longitudinal direction LD to the greatest width WD ranging from 20:1 to 1:1, preferably from 10:1 to 1.5:1 and more preferably from 6:1 to 2:1.

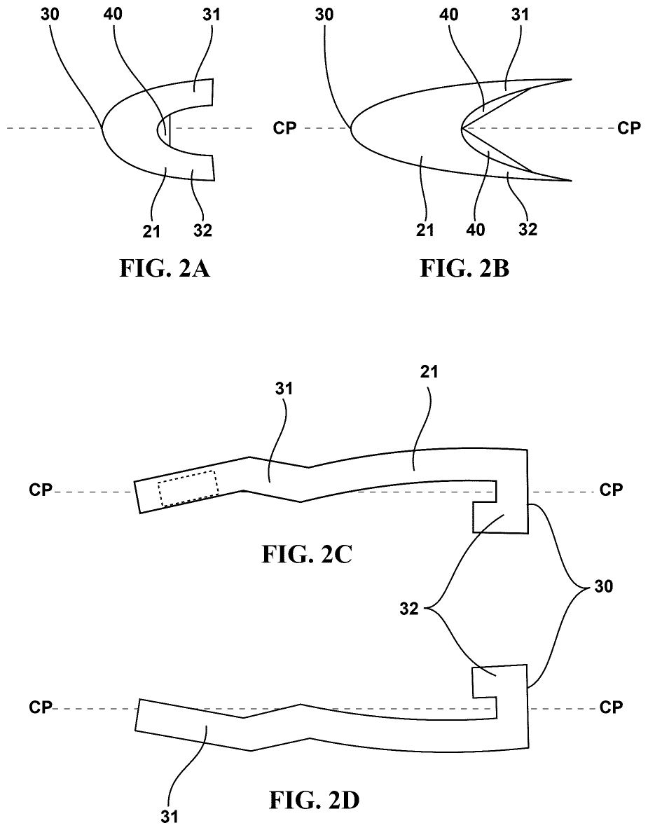

Referring to FIG. 2A, FIG. 2B, FIG. 2C and FIG. 2D, the edge guard 20 may have a C-shaped cross section 21 or a J-shaped cross section 21. The cross section 21 is defined by a first leg 31 and a second leg 32 connected by an apex 30. A central plane CP is disposed at the midpoint of the apex 30 and extends outwardly towards the opening of the channel 35. The first leg 31, second leg 32 and apex 30 may define an edge guard 20 which is symmetric about the central plane CP as shown in FIGS. 2A and 2B or asymmetric about the central plane CP as shown in FIGS. 2C and 2D. The asymmetric configuration may have legs 31, 32 which are equal in width WD taken parallel to the central plane CP according to FIGS. 2A and 2B or legs unequal in width WD taken parallel to the central plane CP according to FIGS. 2C and 2D.

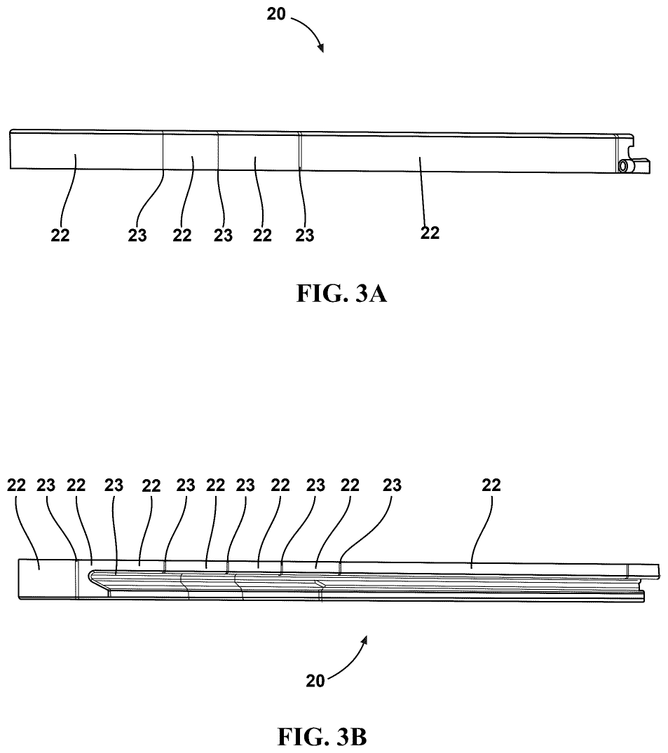

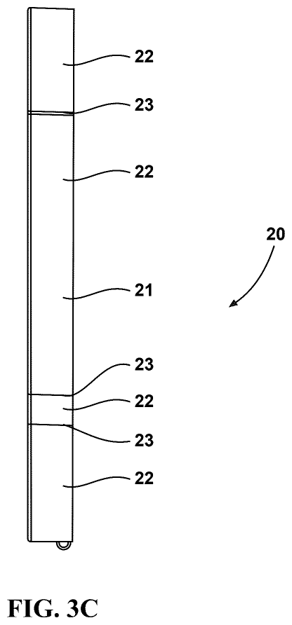

Referring to FIG. 3A, FIG. 3B and FIG. 3C, in profile the edge guard 20 is elongate. The legs 31, 32 of the edge guard 20 may be equal, unequal or substantially equal in length, as shown. The edge guard 20 has at least two segments 22 which have different angles 82 relative to the central plane CP and are separated by a discontinuity 23.

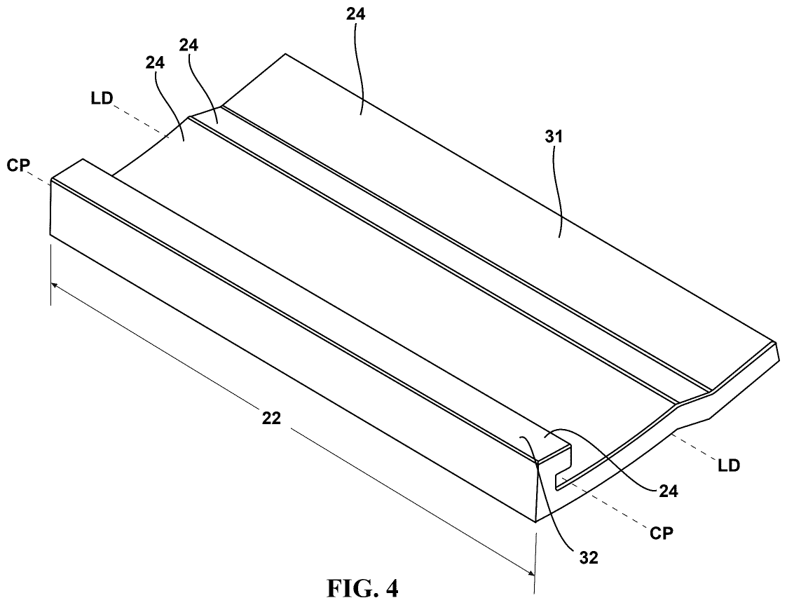

Referring to FIG. 4, a particular segment 22 of the edge guard 20 may be curvilinear, or is preferably straight as shown. The segment 22 defines a longitudinal direction LD, with adjacent segments 22 having mutually different longitudinal directions LD.

Each leg 31, 32, of the segment 22 may have one or more panels 24. The panels 24 provide for specific fit of the edge guard 20 around a door 71, frictional engagement with the door 71 or mass to accommodate magnets 40 as discussed below.

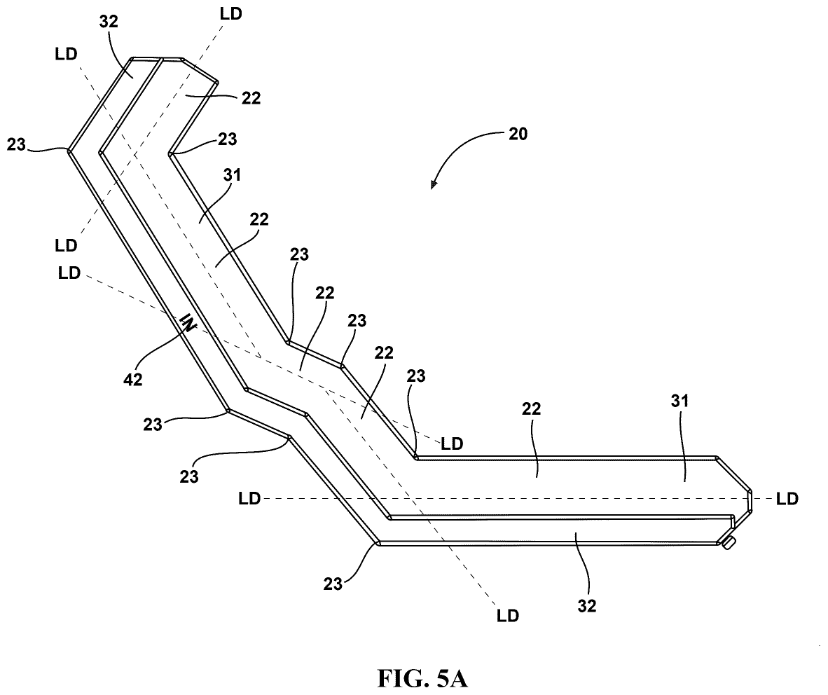

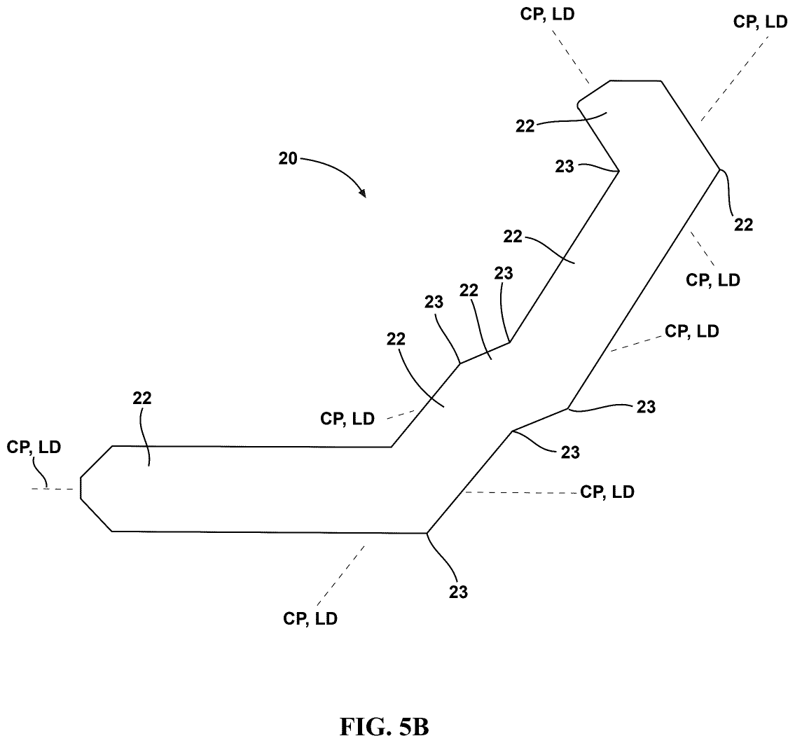

Referring to FIG. 5A and FIG. 5B, the edge guard 20 may have plural segments 22 lying within a common central plane CP but angularly disposed in mutually different longitudinal directions LD. Such an edge guard 20 protect all corresponding sections 72 of a door 71, even at the discontinuities 23. The discontinuities 23 define and separate adjacent segments 22 by changes in the angular orientation of adjacent segments 22, for example with all segments 22 lying within the central plane CP as shown. The discontinuities 23 may comprise both sharp vertices and gradual radii, as shown.

This configuration provides the benefit that a single edge guard 20 having, e.g. 5, segments 22 as shown, can replace up to 5 single segment 22 edge guards 20. Requiring plural single segment 22 edge guards 20 for the task complicates inventory requirements and the maintenance procedures.

Even more advantageously, the present invention provides complete protection of the edge at risk during maintenance. For example, if separate edge guards 20 having single segments 22 are used, the maintainer may skip shorter segments 122 for perceived expediency. In such case only longer segment 222 edge guards 20 will be deployed, leaving other sections 72, particularly the shorter sections 72, of the door 71 unprotected. Or longer segment 222 edge guards 20 may be missing from inventory, but if the maintenance task proceeds anyway, even more door 71 edges are left unprotected.

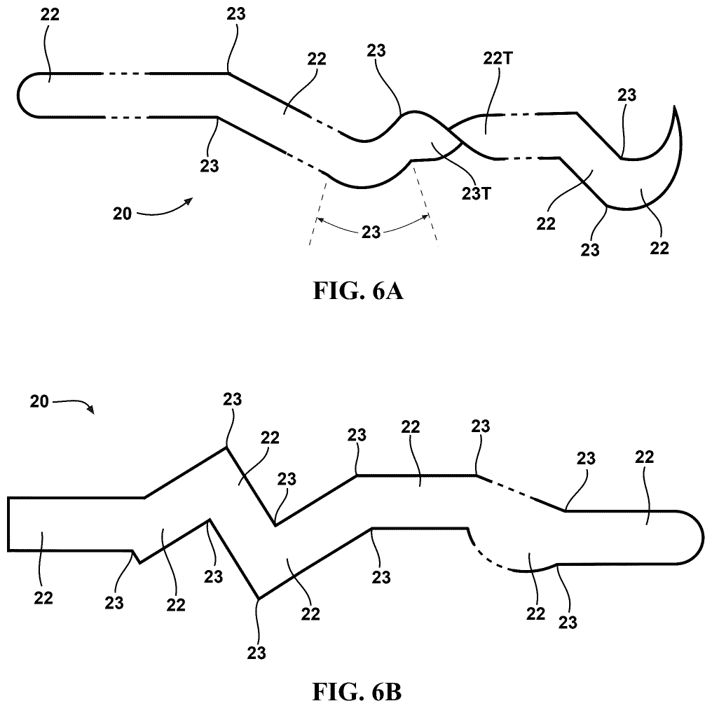

Referring to FIG. 6A and FIG. 6B, the multi-segment 22 edge guard 20 may have plural segments 22 angularly disposed in mutually different longitudinal directions LD relative to the central plane CP. Adjacent segments 22 are separated by discontinuities 23 between the segments 22. The discontinuities 23 may comprise both sharp vertices and radiused apexes 30, as shown.

As discussed above, this arrangement provides the benefit that complex door 71 geometries can be protected, including geometries with out of plane bends in the door 71. As desired, even twisted segments 22T may be used for like geometries of edges to be protected. And as discussed above, such a multi-segment 22 edge guard 20 overcomes the problem of requiring plural single segment 22 edge guards 20.

One of skill will recognize that hybrid edge guards 20 are also feasible and within the scope of the present invention. Such a hybrid edge guard 20 has angularly disposed adjacent segments 22 lying within the in central plane CP according to FIGS. 5A and 5B and has angularly disposed adjacent segments 22 with different central planes CP according to FIGS. 6A and 6B.

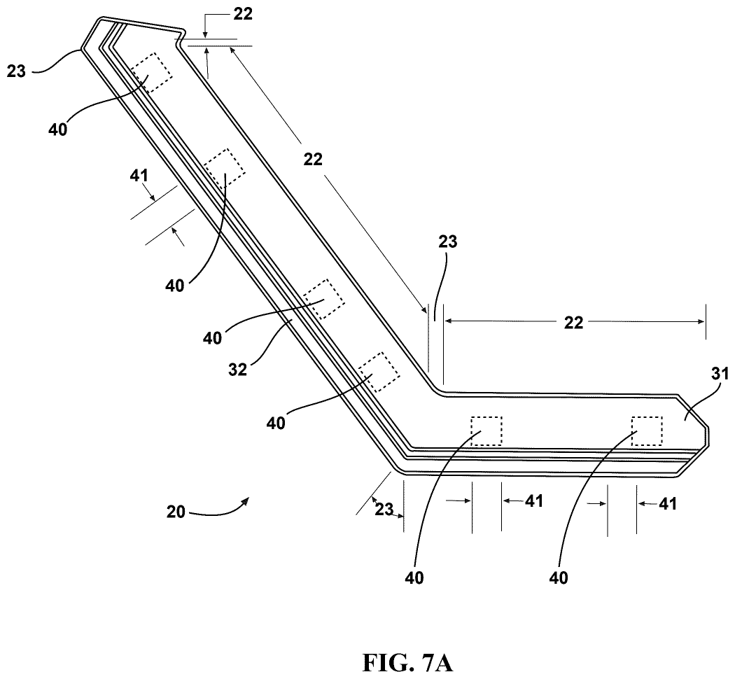

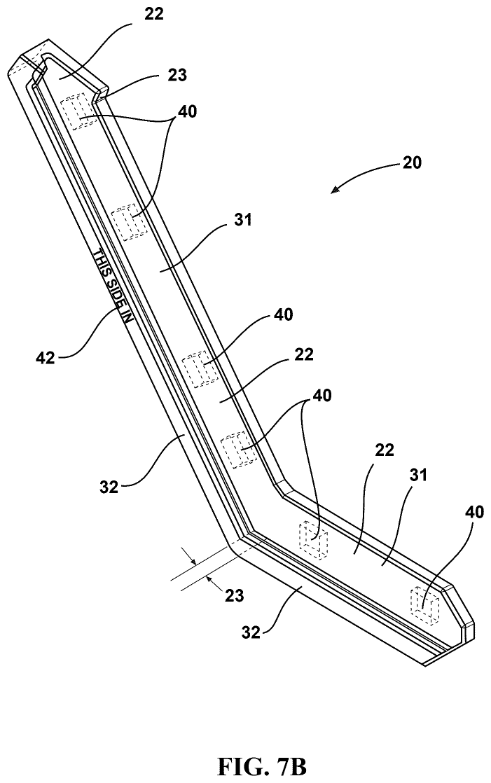

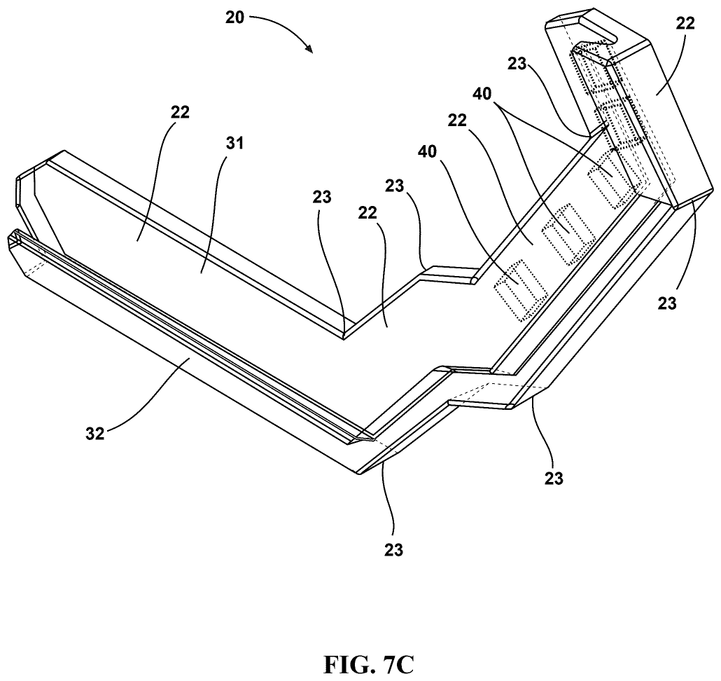

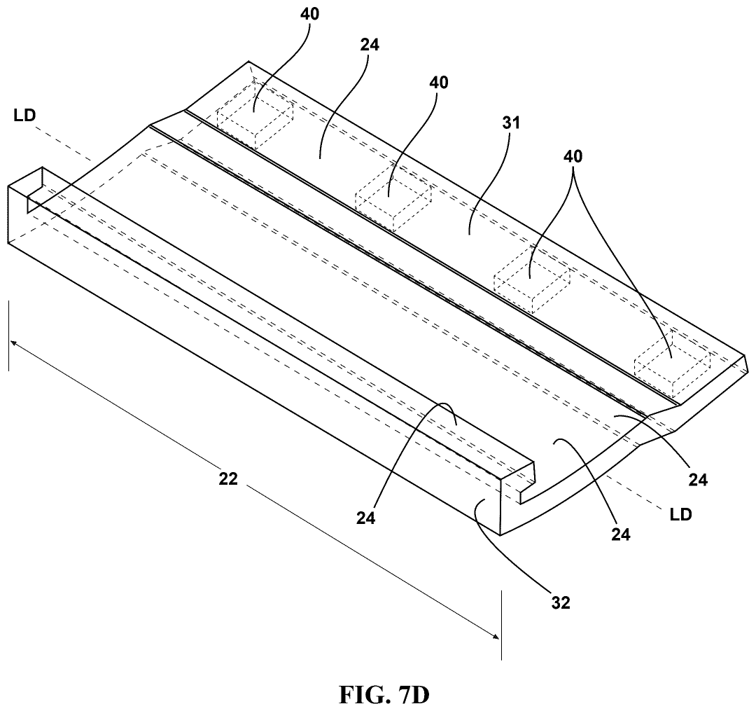

Referring to FIG. 7A, FIG. 7B, FIG. 7C and FIG. 7D, the edge guard 20 has at least one magnet 40 and preferably a plurality of magnets 40. The magnets 40 provide for magnetic attachment and particularly removable attachment of the edge guard 20 to a ferrous door 71 or other ferrous edge without the need for tools or additional equipment. Furthermore, magnetic attachment is judged to be more secure and less damaging than a friction fit which can abrade fragile surfaces, such as low observable coatings.

The magnets 40 are disposed in the segment 22 to effect magnetic attraction into the channel 35 where the ferrous edge is protected by the edge guard 20. The magnets 40 may be disposed at the apex 30 of a segment 22, in either leg, 31, 32 or in both legs 31, 32. In a preferred embodiment the magnets 40 are disposed in a single leg, and particularly the leg 31 having the greater width WD. The magnets 40 may be square, having an associated side length 41. Or the magnets 40 may be elongate and particularly elongate parallel to the longitudinal direction LD.

The magnets 40 may be disposed in the segment 22 or segments 22 of the edge guard 20 having sufficient width WD and length in the longitudinal direction LD to accommodate the fit of the desired magnet 40. Magnets 40 may be adhesively attached to the leg or may be embedded therein during manufacture.

Magnets 40 may be disposed in any segment 22 as judged helpful for removable attachment to the door 71 or other surface during the intended maintenance procedure. Short segments 122 may be free of magnets 40, while the long segments 222 may have magnets 40. Alternating adjacent segments 22 may have magnets 40 and be free of magnets 40. Like or similar segments 22 having magnets 40 may have equal or unequal numbers, sizes and spacings of magnets 40. Square magnets 40 may be spaced apart a distance greater than the side length 41 of the square magnets 40 in order to provide flexibility to that segment 22.

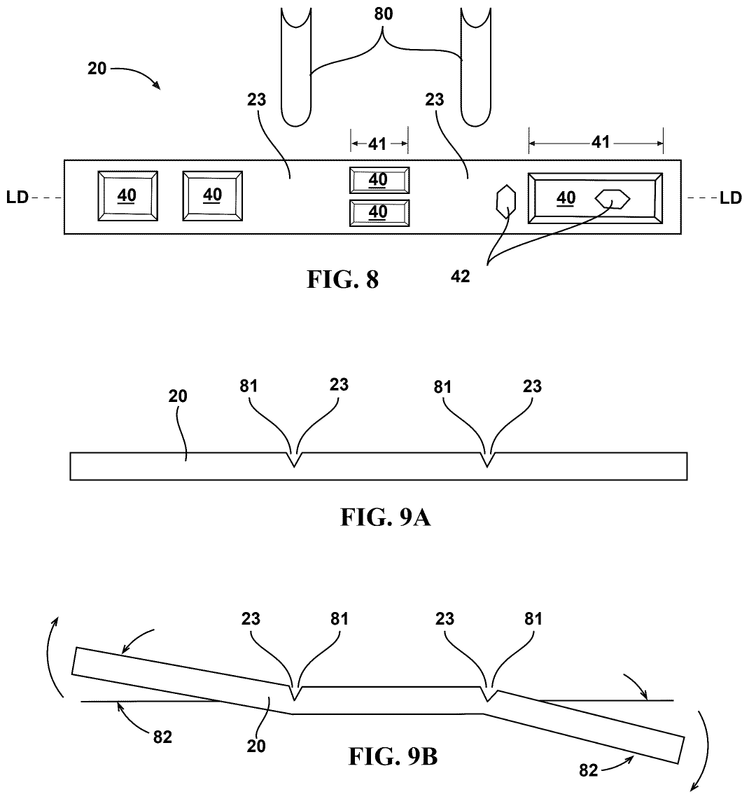

Referring to FIG. 8, the edge guard 20 may be printed using 3D additive manufacturing as is known in the art. TPU or other resilient and shock absorbing may be used.

The edge guard 20 may be printed flat, as a blank 20B. The blank 20B may then be bent, as described below into shapes having various segments 22 as needed for the particular task. By providing blanks 20B, manufacturing flexibility is promoted. Several blanks 20B may be produced in batch and flat stored. Then the blanks 20B may be bent into edge guards 20 as needed and at the point of use. This arrangement provides the benefit that a blank 20B may be bent into various shapes as needed to conform to a particular edge during maintenance. If desired, a blank 20B may be shorted as needed for a particular task and bent into fewer or shorter segments 22.

The edge guard 20 may be bent within the central plane CP according to FIGS. 5A and 5B or bent out of the central plane CP according to FIGS. 6A and 6B by selective and localized heating. The localized heating may be accomplished with a heat source 80 such as radiant heating or preferably with a heat gun. The heat gun localized heat source 80 provides the benefit of portability, i.e. the local heat may be applied to any desired side of the edge guard 20. The local heat is preferably applied at or causes the formation of a discontinuity 23 due to softening and refreezing at the discontinuity 23. The discontinuity 23 becomes flaccid, allowing the blank 20B to be bent.

If desired, the edge guard 20 may further comprise indicia 42. The indica 42 may comprise instructions for use, safety warnings, inventory nomenclature, placement labels for positioning, etc.

Referring to FIG. 9A and FIG. 9B, if desired, the discontinuity 23 may comprise a line of weakness 81 in the blank 20B and particularly a line of weakness 81 in a leg 31, 32 or apex 30 thereof. The line of weakness 81 may be perpendicular to the longitudinal direction LD. The line of weakness 81 may comprise perforations or a hinge. The line of weakness 81 may be used as a discontinuity 23 during manufacture.

The line of weakness 81 may be subjected to localized heating from the heat source 80. Upon localized heating of the line of weakness 81, the discontinuity 23 is used to bend the edge guard 20 at the discontinuity 23 between adjacent segments 22.

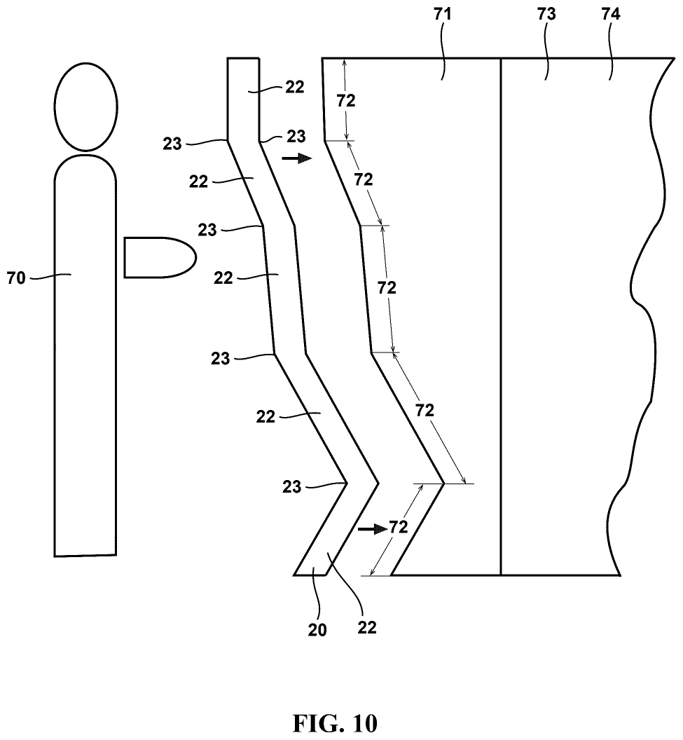

Referring to FIG. 10, in operation a user 70 selects an edge guard 20 having segments 22 which match the geometry of the sections 72 of an edge 75 to be protected. The user 70 stabilizes a door 71 or other sheet geometry having an edge 75 to be protected. The user 70 aligns the edge guard 20 with the edge 75 and applies the edge guard 20 ion the direction of the arrows. The user 70 verifies the magnets 40 are attracted to the respective ferrous sections 72 of the door 71.

While the invention has been described with respect to a WBD of a F-35 aircraft 74, one of skill will understand the invention may be used with other vehicles 73 as well, including other aircraft 74, automobiles, forklifts, etc.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. An edge guard for protecting door edges, the edge guard comprising:
an elongate, resilient channel having a cross section configured to fit a specific door to be protected and a longitudinal direction perpendicular thereto, the channel having a first plurality of contiguous segments and a second plurality of discontinuities therebetween, whereby each segment is non-colinear with an adjacent segment; and
a third plurality of discrete magnets disposed within the cross section, wherein the discontinuities are free of the discrete magnets.

2. An edge guard according to claim 1 wherein the cross section has a first leg and a second leg joined by an apex and the third plurality of magnets is disposed in the first leg with the second leg being free of the magnets.

3. An edge guard according to claim 1 wherein the cross section has a first leg and a second leg joined by an apex and defining a central plane therebetween and at least one discontinuity of the second plurality of discontinuities is within the central plane.

4. An edge guard according to claim 1 wherein the cross section has a first leg and a second leg joined by an apex and defining a central plane therebetween and at least one discontinuity of the second plurality inflects adjacent segments to be biplanar.

5. An edge guard according to claim 4 further comprising at least one discontinuity which lies within the central plane.

6. An edge guard according to claim 5 having a first segment having at least one magnet therein, a second segment having at least one magnet therein and a third segment intermediate the first segment and the second and being free of magnets.

7. An edge guard according to claim 2 having a J-shaped cross section and wherein the first leg has a first leg width and the second leg has a second leg width less than the first leg width.

8. An edge guard according to claim 6 wherein the magnets of the first plurality of magnets are generally square having sides with a side length and the magnets are spaced apart in the longitudinal direction a distance greater than the side length.

9. A longitudinally elongate edge guard for protecting door edges, the edge guard comprising:
a resilient channel having a cross section with a first leg and a second leg joined by an apex and defining a channel therebetween configured to fit a specific door to be protected, the channel having a plurality of n contiguous segments and a plurality of n−1 discontinuities therebetween and being free of any magnet, whereby first and second adjacent segments lie in two different central planes; and
plural discrete magnets disposed within each of the two adjacent segments

10. An edge guard according to claim 9 further comprising a third segment adjacent to the second segment having a common central plane.

11. An edge guard according to claim 10 wherein plural magnets are disposed in the first segment and the third segment, the second segment being free of magnets.

12. An edge guard according to claim 11 wherein the second segment has an aspect ratio of 6:1 to 2:1.

13. An edge guard according to claim 12 wherein both legs of the edge guard have plural magnets embedded therein.

14. An edge guard according to claim 13 further comprising a fourth segment adjacent the third segment, the fourth segment and the second segment having mutually parallel spaced apart central planes.

15. A method of protecting a door edge comprising the steps of:
determining the linear, angular and central plane measurements of plural contiguous sections of a door edge to be protected;
providing an elongate blank having contiguous segments matching the respective linear and angular measurements separated by discontinuities, each of the segments having a respective central plane;
embedding at least one magnet in each segment desired to be adhered to the door;
heating the blank intermediate the at least one magnet in each segment until a localized region becomes flaccid in response to the heating;
bending the blank at the flaccid localized region until the respective central planes of adjacent segments are non-coplanar and match the central plane measurements of the respective door sections;
allowing the flaccid localized regions to harden to yield a resilient non-coplanar edge guard; and
installing the edge guard on the corresponding door edge.

16. A method according to claim 15 further comprising heating a plurality of localized regions intermediate the magnets; and
bending the blank at the plural flaccid localized regions until the respective central planes of adjacent segments are non-coplanar and match the central plane measurements of the respective door sections.

17. A method according to claim 15 wherein the localized regions are coincident respective discontinuities.

18. A method according to claim 17 wherein the providing an elongate, C-cross section blank comprises the steps printing the blank by additive manufacturing and embedding the magnets within the blank during printing.

19. A method according to claim 17 wherein the blank has at least 4 contiguous segments in at least two different central planes.

20. A method according to claim 17 wherein the at least two different central planes are in acute angular relationship.
